(19) United States
(12) Patent Application Publication
(10) Pub. No.: US 2015/0355442 A1
(43) Pub. Date: Dec. 10, 2015

(54) PORTABLE DECORATIVE OBJECT INCLUDING AN ILLUMINATED REGION

(71) Applicant: HOMDEC, Yvorne (CH)

(72) Inventor: Bernard PULFER, Bex (CH)

(21) Appl. No.: 14/759,675

(22) PCT Filed: Jan. 17, 2014
(86) PCT No.: PCT/IB2014/058358

§ 371 Date: Jul. 8, 2015

(30) Foreign Application Priority Data
Jan. 18, 2013 (FR) 13 50429

(51) Int. Cl. G02B 19/00; G02B 5/09

(52) U.S. Cl. CPC G02B 19/0038; G02B 5/09; G02B 19/0019

(57) ABSTRACT

The present invention relates to a portable decorative object including a transparent part including at least one reflective inclined edge oriented so as to receive an incident ambient light perpendicular to an upper face of the transparent part, the inclined edge being oriented so as to send back the perpendicular incident light to inside the transparent part. The object includes a decorative region arranged inside the transparent part, illuminated by the light reflected by the inclined edge.

From international applications WO 2004/015658 and WO 2008/110881, it is well known to produce decorative devices comprising a decorative region back-lit by collecting a vertical incident ambient light.

More particularly, WO 2004/015658 describes a back-lit display comprising a front face having at least one transparent region, and at least one mirror arranged at the back of the front face and oriented so as to reflect a vertical incident external light towards the front face, to ensure the backlighting of the latter.

Furthermore, WO 2008/110881 describes a bottle or a bottle cap comprising a sealed housing and a reflective object arranged inside the housing, the reflective object being oriented so as to receive a vertical incident external light and send back a reflected light onto a transparent region of the object, to ensure the backlighting of the latter.

The present invention originates in the idea of implementing a similar principle for collecting ambient light in the field of small portable decorative objects and in particular in the field of jewelry, to produce objects offering a surprising blaze effect or which appear to be illuminated from inside.

The present invention more particularly relates to a portable decorative object or an object intended to be worn, and/or weighing less than 20 grams, without any light source, comprising a transparent part comprising an upper face, in which the transparent part comprises at least one reflective inclined edge oriented so as to receive an incident ambient light perpendicular to the upper face of the transparent part, the inclined edge being oriented so as to send back the perpendicular incident light to inside the transparent part, the object comprising a decorative region illuminated by the light reflected by the inclined edge.

According to one embodiment, the inclined edge has a 45° angle to within one degree in relation to the upper face of the transparent part.

According to one embodiment, the decorative region comprises an etching performed on a lower face of the transparent part, causing a shape in relief to appear inside the transparent part.

According to one embodiment, the decorative region comprises at least one of the following elements: an object included in the transparent part, combinations of transparent materials of different colors, a colored region included in the transparent part, or air or gas bubbles trapped in the transparent part.

According to one embodiment, the transparent part is a wafer comprising a rear face parallel to its front face.

According to one embodiment, the transparent part is made of a mineral or organic glass.

According to one embodiment, the reflective inclined edge comprises a layer of a reflective material.

According to one embodiment, the object is a piece of jewelry.

According to one embodiment, the object belongs to the group of objects comprising: a watch glass, a cufflink, a top of a ballpoint pen, a decoration of glass side-piece.

Some embodiments of the present invention will be described below, in relation with, but not limited to, the appended drawings, in which:

FIG. 1 is a cross-section of one embodiment of a decorative object according to the present invention,

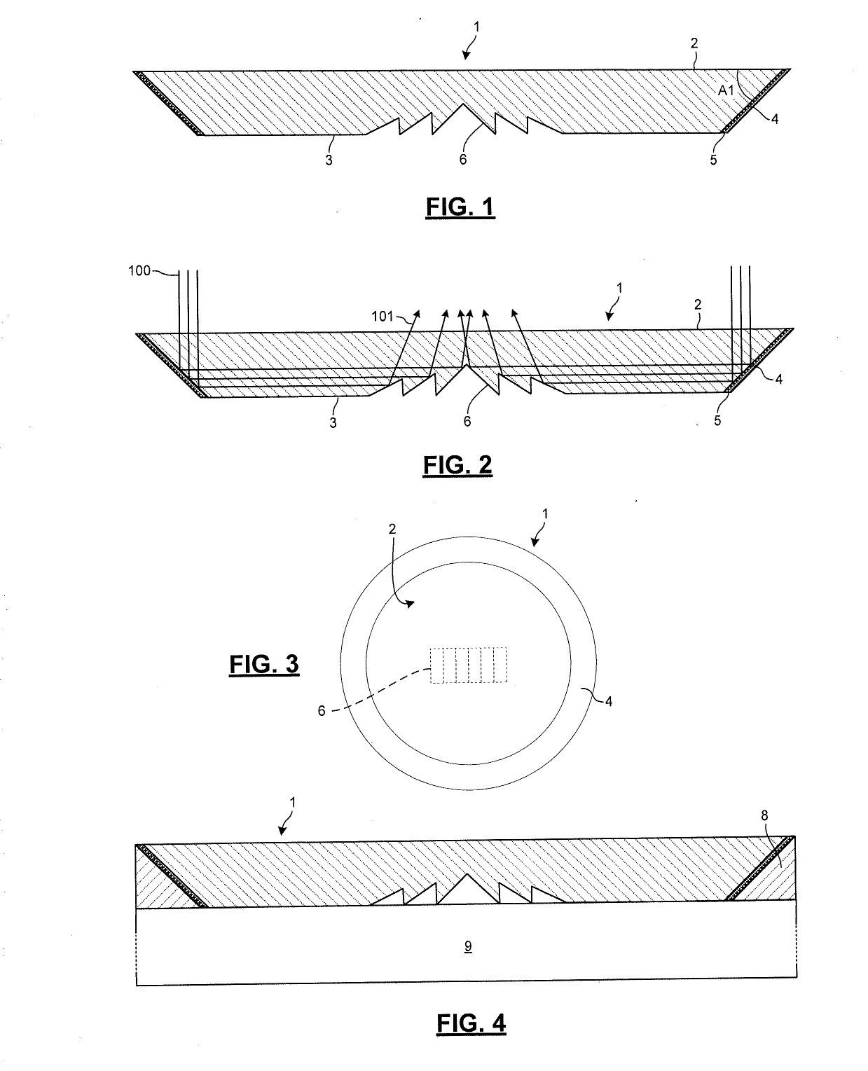

FIG. 2 shows light paths in the decorative object,

FIG. 3 is a top view of a first alternative embodiment of the object of FIG. 1,

FIG. 4 is a cross-section of a second alternative embodiment of the object of FIG. 1,

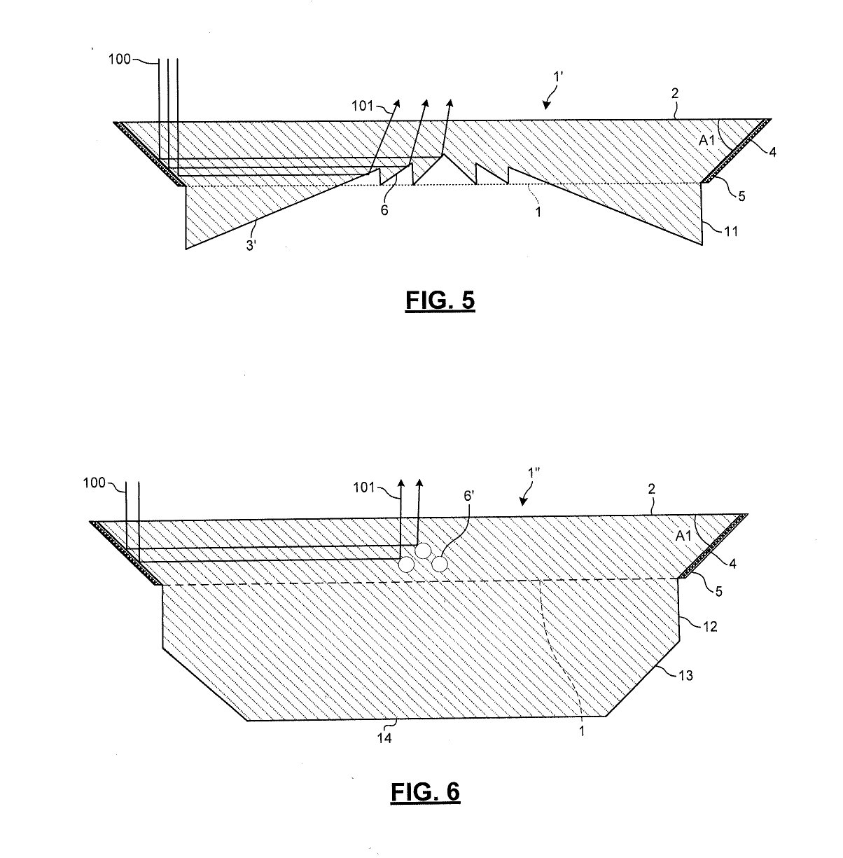

FIG. 5 is a cross-section of a third alternative embodiment of the decorative object of FIG. 1, and

FIG. 6 is a cross-section of a fourth alternative embodiment of the decorative object of FIG. 1.

FIG. 1 is a cross-section of one embodiment of a decorative object according to the present invention. The object is represented in a cross-section and comprises a wafer 1 made of at least one transparent material, such as mineral or organic glass. “Mineral or organic glass” means any type of transparent material commonly used in industry to produce glasses or similar objects, including acrylic, polycarbonate glasses, sapphires, etc.

The wafer 1 comprises a front face 2, a rear face 3 substantially parallel to the front face 2, at least one inclined edge 4 covered with a reflective material 5, and a decorative region 6 situated inside the wafer. The inclined edge 4 here has an angle A1 of the order of 45° in relation to the upper face of the wafer, to within more or less one degree.

The reflective material 5 is for example a thin vapor-deposited layer of chrome (PVD). The thickness of the wafer 1 varies according to the intended application, and may be of the order of a few millimeters, for example 1 to 5 mm.

The decorative region here comprises an etched region 6 on the rear face of the wafer 1, causing hollow patterns to appear inside the wafer that extend in the thickness of the latter. These patterns extend over a fraction of the thickness of the wafer, for example between 2 and 5 tenths of this thickness.

FIG. 2 represents an example of a path of a vertical incident ambient light 100 perpendicular to the front face 2, the wafer being assumed to be arranged horizontally. The light 100 reflects on the inner face of the inclined edge 4, thanks to the material 5, to form a reflected light 101 that is sent back towards the interior of the wafer, here in a direction parallel to the front face 2, and which illuminates the etching 6.

The result is a blaze effect of the etching 6, when observing the latter from the top, through the wafer 1, as shown on FIG. 3.

So that the light reflects sufficiently on the etched portion 6, the latter is preferably a mat etching (not polished). It can be done by a mechanical method such as sand-blasting or shot-peening.

In alternative embodiments, the decorative region 6 may comprise an object included in the wafer, combinations of transparent materials of different colors, air or gas bubbles trapped in the wafer, etc.

The reflective material 5 may comprise a combination of colored chromes, to introduce color variations into the light it reflects, or other reflective materials such as silver or gold.

The wafer 1 seen from the top may have a circular general shape, as shown on FIG. 3, or triangular, parallelepipedal, polygonal, etc. If it is not circular, it comprises several edges. Each of these edges may then be provided inclined and reflective, or only a portion of them. The angle of inclination of each edge may vary, to illuminate different regions of the wafer.

In one alternative embodiment represented in FIG. 4, the wafer is surrounded by a frame 8, of circular, triangular, parallelepipedal or polygonal shape adapted to that of the wafer. The frame may be made of metal, or of mineral or organic glass and has an inclined inner face which moulds the external shape of the wafer and covers the inclined edge 4. The wafer 1 thus held by the frame 4 is here mounted on a support 9, which may be hollow or solid.

Those skilled in the art may further provide other embodiments of this invention. As an example, FIG. 5 represents a transparent part 1′ with a complex shape forming one alternative embodiment of the wafer 1 (FIG. 1) including the initial shape of the latter, as shown by dotted lines. The part 1′ has a rear face 3′ with a non-flat surface, obtained for example by etching. The part 1′ also comprises another edge 11, continuing the edge 4, which forms a rim with the rear face 3′. The etched decorative region 6 is present in the center of the rear face 3′, and here has the same shape as that of the wafer 1.

As another example, FIG. 6 represents a transparent part 1″ also forming one alternative embodiment of the wafer 1 (FIG. 1) including the initial shape of the latter, as shown by dotted lines. The part 1″ is of polyhedral type and has a rear part with a complex shape comprising several faces 12, 13, 14, the face 12 continuing the edge 4 of the wafer 1, the face 14 forming the rear face of the part 1″. The edge 4 itself forms a face of the part 1″ and is thus no longer a wafer edge per se. In this embodiment, the decorative region comprises air or gas bubbles 6′ trapped in the material forming the part, on which an incident light 100 reflects, the reflected light 101 causing the decorative region to appear as illuminated from the inside. It goes without saying that, in such embodiments, the upper face of the object could also be not flat.

In various embodiments, a decorative object according to the present invention is portable and intended to be worn or kept with oneself. In other embodiments, a decorative object according to the present invention weighs less than 20 grams, including the decorative region. The present invention is in particular applicable to the production of jewelry (ring, pendant, earring, etc.), of parts of jewelry, or even of portable decorative objects or of parts of portable decorative objects having, in addition to a technical function, a decorative function similar to that of the jewelry, such as: watch glass, cufflink or cufflink decoration, top of a ballpoint pen, decoration of glass side-piece, etc. An application to mobile phone cases can also be considered.

In addition to the mineral or organic glass, the transparent wafer 1,1′,1″ may also be made of precious stone or semi-precious stone, or even of plastic, such as polymethyl methacrylate. In certain applications, the 45° angle may vary to within more than one degree according to the location of the inner part of the object that must be illuminated, and may for example range between 40 and 50°.

1. A portable decorative object or a decorative object intended to be worn, and/or weighing less than 20 grams, without any light source, comprising a transparent part comprising an upper face, wherein:
the transparent part comprises at least one reflective inclined edge oriented so as to receive an incident ambient light perpendicular to the upper face of the transparent part,
the inclined edge is oriented so as to send back the perpendicular incident light to inside the transparent part,
and in that it comprises a decorative region illuminated by the light reflected by the inclined edge.

2. Object according to claim 1, wherein the inclined edge has a 45° angle to within one degree in relation to the upper face of the transparent part.

3. Object according to claim 1, wherein the decorative region comprises an etching performed on a lower face of the transparent part, causing a shape in relief to appear inside the transparent part.

4. Object according to claim 1, wherein the decorative region comprises at least one of the following elements: an object included in the transparent part, combinations of transparent materials of different colors, a colored region included in the transparent part, or air or gas bubbles trapped in the transparent part.

5. Object according to claim 1, wherein the transparent part is a wafer comprising a rear face parallel to its front face.

6. Object according to claiim 1, wherein the transparent part is made of a mineral or organic glass.

7. Object according to claim 1, wherein the reflective inclined edge comprises a layer of a reflective material.

8. Object according to claim 1, forming a piece of jewelry.

9. Object according to claim 1, belonging to the group of objects or forming a part of an object from the group of objects comprising: a watch glass, a cufflink, a top of a ballpoint pen, a decoration of glass side-piece.
